(19) United States
(12) Patent Application Publication
(10) Pub. No.: US 2024/0162523 A1
(43) Pub. Date: May 16, 2024

(54) Battery for a motor vehicle

(71) Applicant: Webasto SE, Stockdorf (DE)

(72) Inventor: Fritz Wegener, Stockdorf (DE)

(21) Appl. No.: 18/389,355

(22) Filed: Nov. 14, 2023

(30) Foreign Application Priority Data
Nov. 15, 2022 (DE) 102022130226.1

(51) Int. Cl. H01M 10/653; H01M 10/625; H01M 10/6554; H01M 10/6556; H01M 50/258; H01M 50/264; H01M 50/588; H01M 50/593

(52) U.S. Cl. CPC H01M 10/653; H01M 10/625; H01M 10/6554; H01M 10/6556; H01M 50/258; H01M 50/264; H01M 50/588; H01M 50/593; B60L 50/64; H01M 2220/20

(57) ABSTRACT

A for a motor vehicle, comprising a battery module and a temperature-control plate, where a thermally conductive paste is arranged between the battery module and the temperature-control plate, where an electrically insulating spacer is arranged between the battery module and the temperature-control plate.

### CROSS-REFERENCE TO RELATED APPLICATION

This application claims priority to German Application No. DE 10 2022 130 226.1 filed on Nov. 15, 2022, which is incorporated herein by reference in its entirety for all purposes.

### TECHNICAL FIELD

The present invention relates to a battery, in particular to a traction battery for a motor vehicle.

### BACKGROUND

The performance requirements for modern batteries are continually increasing, with development being focused on using available installation space and materials as optimally as possible in order to increase the power-to-weight ratio. Safety is always a consideration during development, for example in order to prevent short circuits.

Batteries may have a battery housing in which one or more battery modules are installed. The actual battery cells are organized mechanically, logically and electrically in the battery modules. A temperature-controlling plate for controlling the temperature of the battery modules may be provided, wherein a temperature-controlling medium typically flows through the temperature-controlling plate in order to allow cooling or heating of the battery cells.

The battery modules may in this case be thermally connected to the temperature-controlling plate by means of a thermally conductive medium. A thermally conductive paste may be arranged between the battery module and temperature-control plate as thermally conductive medium.

DE 10 2021 000 981 A1 discloses introducing a structural mat between the battery cell and housing base in order to make disassembly easier, in particular to make it easier to remove battery cells.

### DISCLOSURE OF THE INVENTION

Proceeding from the known prior art, one object of the present invention is to provide a further improved battery.

The object is achieved by a battery, preferably a traction battery for a motor vehicle, having the features of claim 1. Advantageous developments will become apparent from the dependent claims, the description and the figures.

What is accordingly proposed is a battery, in particular a traction battery for a motor vehicle, comprising a battery module and a temperature-control plate, wherein a thermally conductive paste is arranged between the battery module and the temperature-control plate. According to the invention, an electrically insulating spacer is arranged between the battery module and the temperature-control plate.

The arrangement of a spacer allows a minimum distance in the form of a clearance to be ensured between the battery module and the temperature-control plate, with the result that the electrical insulation between the battery module and temperature-control plate can be maintained due to unevennesses on the temperature-control plate or due to particles, such as metal chips, for example, in the clearance.

So that the spacer does not form an electrically conductive bridge between the battery module and temperature-control plate, it is made of an electrically insulating material, preferably a plastic.

Accordingly, the electrically insulating spacer may have a thickness that ensures a predetermined clearance between the battery module and the temperature-control plate.

This arrangement of the spacer additionally makes it possible to ensure a minimum clearance distance between the battery module and the temperature-control plate without an additional safety margin, thereby enabling a compact design and advantageous and effective temperature control of the battery module.

Moreover, this allows a smaller volume of thermally conductive paste to be used compared to known applications, since only the clearance thickness that is actually required needs to be filled with thermally conductive paste, rather than a clearance thickness that has been increased due to safety margins. Securely setting a predefined minimum clearance distance accordingly allows the amount of thermally conductive paste to be reduced and kept to a minimum, as a result of which costs and weight can be saved. Furthermore, the reduced use of thermally conductive paste also has an advantageous effect on the durability of the battery.

The electrically insulating spacer may have a thermal conductivity that corresponds to the thermal conductivity of the thermally conductive paste. This allows a particularly homogeneous transfer of heat, which extends over the entire surface area of the temperature-control plate, to be achieved.

An underside of the spacer, which is supported on an upper side of the temperature-control plate, may be formed such that the underside of the spacer and the upper side of the temperature-control plate can make full-surface contact. The upper side of the spacer may accordingly make contact with an underside of the battery module, wherein the contact may be full-surface contact.

The contact between the battery module and the spacer is used to set the desired minimum clearance distance. At the same time, this results in the battery module being further supported with respect to the temperature-control plate, which may have an advantageous effect on the overall stability of the battery.

The electrically insulating spacer may be adhesively bonded to the temperature-control plate. This results in reliable positioning of the spacer and therefore in simplified assembly of the battery.

In the assembled state, the thickness of the electrically insulating spacer may in this case result in the temperature-control plate being elastically and/or plastically deformed. For example, the electrically insulating spacer may virtually push the temperature-control plate away, at least in the region in which the spacer bears against the temperature-control plate, when the battery module presses against the electrically insulating spacer during assembly.

In this case, the material selected for the temperature-control plate, for example the alloy of the material for the temperature-control plate, can be used to ensure that the forces acting on the battery module as a result of the deformation remain within the permissible range.

In another arrangement, the thickness of the electrically insulating spacer may, however, also lead to there being another clearance between the electrically insulating spacer and the temperature-control plate and/or the battery module, and this clearance is then also at least partially filled with thermally conductive paste. This situation may also arise, for example, when the displacement resistance of the thermally conductive paste causes the clearance between the battery module and temperature-control plate to remain larger than the thickness of the electrically insulating spacer.

The electrically insulating spacer may be arranged on a median plane of the battery module. For example, the spacer is arranged centrally on an upper side of the temperature-control plate that faces the battery module, and the battery module is arranged such that the spacer is arranged centrally on the underside of the battery module. In a sectional view, the spacer, the temperature-control plate and the battery module thus have a common median plane.

In one advantageous embodiment, the spacer has a length that is smaller than or equal to a length of the battery module that extends in a parallel direction.

This allows contact to be made between the battery module and the spacer over the largest possible direction of extent, as a result of which a constant clearance distance can be ensured. Nevertheless, in order to make a compact design of the battery possible and to provide advantageous temperature-control properties, the length of the spacer is smaller than or equal to the length of the battery module.

The electrically insulating spacer may be arranged at a position on the temperature-control plate that is located within an area of the temperature-control plate formed by fastening devices for fastening the battery module, for example in a central region of this area.

Thus, the spacer may be arranged between the fastening devices in the region with the largest amount of sagging, thereby achieving further support for the battery module. At the same time, the formation of the correct dimensions of the clearance is also achieved by the spacer in this region with the largest amount of sagging.

The thermally conductive paste may surround the spacer at least laterally.

Surrounding the spacer with the thermally conductive paste results in advantageous temperature control of the battery module, even in the region of the spacer, with the result that substantially homogeneous temperature control may be achieved here.

The electrically insulating spacer may have a constant cross section over its length, wherein the cross section may be quadrilateral or rectangular.

Firstly, this achieves simple and cost-effective manufacturing of the spacer. Secondly, the constant cross section results in a uniform load distribution over the length of the spacer. In order to advantageously form the contact surfaces between the spacer and battery module as well as temperature-control plate, the respective contact surface of the spacer is formed so as to be parallel to the contact surface of the component (temperature-control plate or battery module) in contact therewith.

A height of the spacer may be smaller than the length or a width of the spacer. This form is cost-effective and reduces the weight. Furthermore, the contact surface is relatively large, as a result of which a constant clearance distance and an improved load distribution can be ensured.

The spacer may be formed in one piece.

The one-piece form of the spacer is cost-effective to produce and offers structural advantages in terms of the arrangement between the temperature-control plate and the battery module. In addition, a one-piece form of the spacer results in a more uniform force distribution over the surface and may thus have a positive effect on uniform deformation of the temperature-control plate.

The temperature-control plate may have a recess that forms a receptacle for the electrically insulating spacer, the electrically insulating spacer may then be arranged in the recess and the electrically insulating spacer may in this case protrude beyond the plane formed by the temperature-control plate.

In order to form the recess in the temperature-control plate, the latter is permanently deformed, preferably by means of deep drawing. Following the deformation, the recess may have a support surface that may receive the underside of the spacer. This ensures that the spacer is advantageously supported in the recess, as a result of which a constant clearance distance can be produced. Moreover, the structural loading of the temperature-control plate in the assembled state is advantageous.

In this case, the dimensions of the spacer are formed such that, after it has been arranged in the recess, the spacer protrudes out of the recess and thus out of the plane formed by the temperature-control plate, as a result of which the desired clearance distance between the battery module and the temperature-control plate can be ensured.

There may be at least two electrically insulating spacers per battery module.

This allows an improved load distribution and an ensured clearance distance to be achieved. The arrangement and form of the further spacers is arbitrary in this case, wherein the further spacers at least have electrically insulating properties, with the result that a short circuit is prevented and the further spacers are formed so as to ensure a uniform clearance distance.

For example, the further spacers may run parallel and/or orthogonally with respect to one another.

This allows an advantageous load distribution and an ensured clearance on the underside of the battery module to be ensured. If the further spacers are arranged such that the further spacers overlap with one another or with the spacer, then the further spacers should be formed such that the upper sides of the further spacers and of the spacer form a plane. For example, this may be achieved by dividing the further spacers such that contact at mutually facing sides of the further spacers or of the spacer is possible, with the application not being limited to the options mentioned herein for arranging the further spacers.

The temperature-control plate may comprise a base plate and cooling channels and, in this way, fundamentally form a conventional temperature-control plate.

### BRIEF DESCRIPTION OF THE FIGURES

Preferred further embodiments of the invention will be explained in more detail by the following description of the figures, in which:

FIG. 1 shows a schematic sectional view through a battery, and

FIG. 2 shows a perspective view of a temperature-control plate.

### DETAILED DESCRIPTION OF PREFERRED EXEMPLARY EMBODIMENTS

Preferred exemplary embodiments are described below with reference to the figures. In this case, identical, similar or functionally identical elements in the various figures are provided with identical reference signs, and a repeated description of these elements is in some cases dispensed with in order to avoid redundancies.

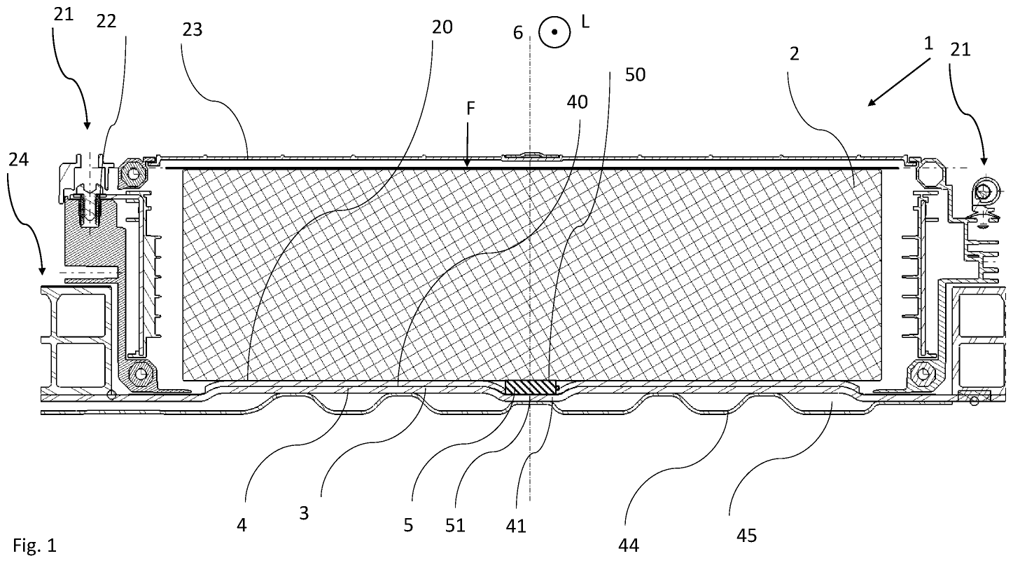

FIG. 1 shows a schematic sectional view through a portion of a battery 1, comprising a battery module 2 and a temperature-control plate 4. The battery 1 has a housing (merely indicated here), which has, for example, a cover 23, the temperature-control plate 4, which is designed as the base of the housing, and lateral fastening structures 24 for fastening the battery module 2 in the housing.

A thermally conductive paste 3 is arranged between the battery module 2 and the temperature-control plate 4 in order to produce a thermal connection between the temperature-control plate 4 and the battery module 2 and, in this way, to allow efficient temperature control of the battery cells received in the battery module 2.

The battery module 2 is fitted to the lateral fastening structures 24 of the housing by means of a fastening device 21. For this purpose, the fastening device 21 comprises, for example, a screw bolt 22, which is used to screw the battery module 2 onto the lateral fastening structures 24 of the housing and to fix the battery module in a predetermined position. The fastening device 21 also ensures that the battery module 2 is positioned in a predetermined manner with respect to the temperature-control plate 4. The fastening device 21 may also be provided in the form of a latch or another screwless fastening, for example.

The thermally conductive paste 3 arranged between the battery module 2 and the temperature-control plate 4 is distributed and partially displaced during the process of fastening the battery module 2 onto the lateral fastening structure 24 of the housing, so as to produce substantially gap-free wetting with the thermally conductive paste 3 and accordingly a substantially full-surface thermal connection between the battery module 2 and the temperature-control plate 4. The thermally conductive paste 3 also provides electrical insulation.

In order to prevent direct contact from being made between the battery module 2 and the temperature-control plate 4, which could result in electrical contact and thus, in extreme cases, in a short circuit, an electrically insulating spacer 5, which is arranged between the temperature-control plate 4 and the battery module 2, is provided. For example, the spacer 5 may be used to prevent the case in which vibrations during the driving operation or flowing of the thermally conductive paste 3 may subsequently lead to inadequate electrical insulation between the battery module 2 and the temperature-control plate 4 as a result of an insufficient thickness of thermally conductive paste 3 arranged therebetween.

The thickness of the spacer 5 may be set such that a minimum distance between the battery module 2 and the temperature-control plate is maintained at all times. This minimum distance is preferably also larger than a maximum size of dirt particles, for example metal chips, that could be present during assembly of the battery. Accordingly, it can be ensured that the electrical insulation between the battery module 2 and the temperature-control plate 4 is maintained even in the event of unwanted ingress of contaminants during the assembly process.

In the assembled state, the thickness of the electrically insulating spacer 5 may in this case result in the temperature-control plate 4 being elastically and/or plastically deformed. For example, the electrically insulating spacer 5 may virtually push the temperature-control plate 4 away, at least in the region in which the spacer 5 bears against the temperature-control plate 4, when the battery module 2 presses against the electrically insulating spacer 5 during assembly.

In this case, the material selected for the temperature-control plate 4, for example the alloy of the material for the temperature-control plate 4, can be used to ensure that the forces acting on the battery module 2 as a result of the deformation remain within the permissible range.

In another arrangement, the thickness of the electrically insulating spacer 5 may, however, also lead to there being another clearance between the electrically insulating spacer 5 and the temperature-control plate 4 and/or the battery module 2, and this clearance is then also at least partially filled with thermally conductive paste 3. This situation may also arise, for example, when the displacement resistance of the thermally conductive paste 3 causes the clearance between the battery module 2 and temperature-control plate 4 to remain larger than the thickness of the electrically insulating spacer 5.

The spacer 5 may be arranged in a position that is predetermined by the geometrical arrangement of the battery module 2, the temperature-control plate 4 and the fastening devices 21 with respect to one another.

For example, the spacer 5 may be arranged, as in the exemplary embodiment shown herein, centrally between the fixed fastening points predetermined by the fastening devices 21. At this position or in this region, there is virtually the maximum amount of sagging and potentially the greatest possible deformation of the battery module 2 and/or the temperature-control plate 4 due to vibrations. The spacer 5 may therefore achieve its best effect in this region.

However, the spacer 5 may also be arranged at other positions on the temperature-control plate 4, for example between the vibration nodes of the temperature-control plate 4, when operating conditions cause the latter to vibrate.

The thickness of the spacer 5 may be designed such that the spacer is clamped between the battery module 2 and the temperature-control plate 4, when the battery module 2 is attached to the lateral fastening structure 24 by way of the fastening device 21. In other words, in the assembled state, a slight deformation of the temperature-control plate 4 and/or of the battery module 2 and/or of the spacer 5 may occur such that a small pretension is applied.

In the exemplary embodiment shown, the spacer 5 is rectangular and formed in one piece from a plastics material. In this case, the spacer 5 makes full-surface contact, on an upper side 50, with an underside of the battery module 20 and makes full-surface contact, on an underside 51, with an upper side of the temperature-control plate 40 in the region of the deformation 41. This ensures an advantageous load distribution via the surfaces in contact.

For example, the spacer 5 and the battery module 2 are arranged on the temperature-control plate 4 such that the spacer 5 is arranged on a median plane 6 with respect to the battery module 2. In this respect, the spacer 5 is arranged centrally on the upper side of the temperature-control plate 40 and the battery module 2 is arranged such that the spacer 5 is arranged centrally on the battery module.

Furthermore, the spacer 5 has a length that is smaller than a length of the battery module 2 that extends in a parallel direction. The direction of extent L, which is shown in FIG. 1, is an axis that runs parallel to the length of the battery module 2 and to the length of the spacer 5. The spacer 5 can also have the same length as the battery module 2.

The spacer 5 is arranged at a position on the temperature-control plate 4 that is located within an area of the temperature-control plate 4 formed by the fastening devices 21 for fastening the battery module 2. The spacer may be located in a central or inner region of this area. In other words, the area is delimited by the fastening devices 21 such that the spacer 5 is located within the delimitation formed by the fastening devices 21.

In order to ensure optimal temperature control of the battery module 2, thermally conductive paste 3 is arranged over the full surface in the clearance formed by the spacer 5 between the battery module 2 and the temperature-control plate 4. In this case, the thermally conductive paste 3 makes contact with the full surface, including the periphery, of the spacer 5, thereby enabling optimal temperature control, even in the region of the spacer 5.

When the spacer 5 and the thermally conductive paste 3 have an identical or similar heat transfer coefficient, a particularly homogeneous transfer of heat can take place in this case.

For this purpose, the thermally conductive paste 3 may be applied after the spacer 5 has been arranged on the temperature-control plate 4 and then the battery module 2 may be fitted.

The temperature-control plate 4 comprises a base plate 44 and cooling channels 45. A temperature-control medium (not shown) may be conducted through the cooling channels 45, with the result that heat is removed from, or heat is supplied to, the battery module 2, depending on the operating state of the battery 1.

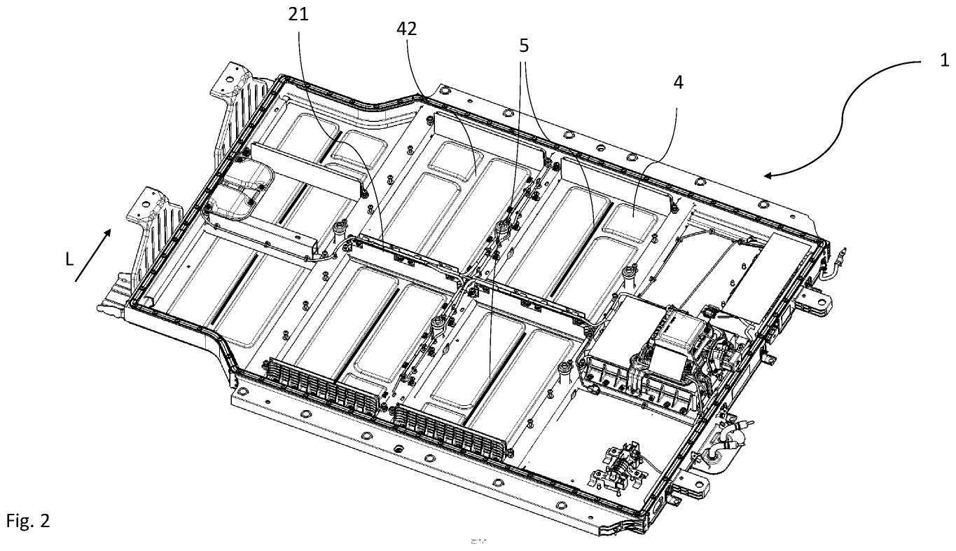

FIG. 2 shows a perspective view of a temperature-control plate 4. The temperature-control plate 4 has a plurality of recesses 42 in which spacers 5 are arranged.

The temperature-control plate 4 is deformed by means of deep drawing in order to introduce the recesses 42, with the result that the temperature-control plate 4 has a defined support surface for spacers 5. After a spacer 5 has been arranged in the recess 42, the spacer 5 protrudes out of the recess 42, in order, in this way, to achieve the spacing between the battery module 2 and temperature-control plate 4. This allows a support surface for the battery module 2 to be created, wherein the arrangement ensures a minimum clearance between the battery module 2 and temperature-control plate 4.

Where applicable, all individual features set forth in the exemplary embodiments may be combined with one another and/or exchanged without departing from the scope of the invention.

### LIST OF REFERENCE SIGNS

1 battery
2 battery module
3 thermally conductive paste
4 temperature-control plate
5 spacer
6 median plane
20 underside of the battery module
21 fastening device
22 screw bolt
23 cover
24 lateral fastening structures
40 upper side of the temperature-control plate
41 deformation
42 recess
43 cooling device
44 base plate
45 cooling channel
50 upper side of the spacer
51 underside of the spacer
L direction of extent

1. A battery, comprising a battery module and a temperature-control plate, wherein a thermally conductive paste is arranged between the battery module and the temperature-control plate, wherein
an electrically insulating spacer is arranged between the battery module and the temperature-control plate.

2. The battery according to claim 1, wherein the electrically insulating spacer has a thermal conductivity that corresponds to the thermal conductivity of the thermally conductive paste.

3. The battery according to claim 1, wherein
the electrically insulating spacer has a thickness that ensures a predetermined clearance between the battery module and the temperature-control plate.

4. The battery according to claim 1, wherein the electrically insulating spacer has a thickness that results, when a battery module is arranged on the temperature-control plate, in at least one of: an elastic and/or plastic deformation of the temperature-control plate, at least in the region in which the electrically insulating spacer bears against the temperature-control plate.

5. The battery according to claim 1, wherein the electrically insulating spacer is adhesively bonded to the temperature-control plate.

6. The battery according to claim 1, wherein the electrically insulating spacer is arranged on a median plane of the battery module.

7. The battery according to claim 1, wherein the electrically insulating spacer is arranged at a position on the temperature-control plate that is located within an area of the temperature-control plate formed by fastening devices for fastening the battery module.

8. The battery according to claim 1, wherein the electrically insulating spacer has a length that is smaller than or equal to a length of the battery module that extends parallel thereto.

9. The battery according to claim 1, wherein the thermally conductive paste surrounds the electrically insulating spacer at least laterally.

10. The battery according to claim 1, wherein the electrically insulating spacer has a constant cross section over its length.

11. The battery according to claim 1, wherein the temperature-control plate has a recess that forms a receptacle for the electrically insulating spacer, the electrically insulating spacer is arranged in the recess and the electrically insulating spacer protrudes beyond the plane formed by the temperature-control plate.

12. The battery according to claim 1, wherein there are at least two electrically insulating spacers per battery module.

13. The battery according to claim 7, wherein the electrically insulating spacer is arranged at the position on the temperature-control plate that is located in a central region of the area of the temperature-control plate formed by fastening devices for fastening the battery module.

14. The battery according to claim 10, wherein the constant cross section of the electrically insulating spacer has a quadrilateral form.

15. The battery according to claim 10, wherein the constant cross section of the electrically insulating spacer has a rectangular form.
